(19) United States
(12) Patent Application Publication
(10) Pub. No.: US 2020/0012146 A1
(43) Pub. Date: Jan. 9, 2020

(54) ELECTRONIC DEVICE

(71) Applicant: InnoLux Corporation, Miao-Li County (TW)

(72) Inventors: Hsiao-Lang Lin, Miao-Li County (TW); Tsung-Han Tsai, Miao-Li County (TW); Kuan-Feng Lee, Miao-Li County (TW)

(21) Appl. No.: 16/027,367

(22) Filed: Jul. 5, 2018

(51) Int. Cl. G02F 1/1335

(52) U.S. Cl. CPC G02F 1/133528; G02F 2203/05; G02F 2001/133548; G02F 1/133617

(57) ABSTRACT

An electronic device including a base substrate and an optical substrate is provided. The optical substrate is disposed opposite to the base substrate and includes an optical region with a plurality of polarizing wires formed therein. A transmittance of the optical region in a wavelength range from 510 nm to 550 nm is ranged from 34% to 57%, or a transmittance of the optical region in a wavelength range from 610 nm to 650 nm is ranged from 37% to 57%.

### BACKGROUND OF THE DISCLOSURE

### 1. Field of the Disclosure

The present disclosure relates to an electronic device, and more particularly, to an electronic device including polarizing wires.

### 2. Description of the Prior Art

Electronic device, such as a liquid crystal display device (LCD) or other functional electronic device, includes an array circuit for driving functional units, such as pixels, in the device. It is known that a plurality of scan lines, a plurality of data lines or a plurality of transistors of the array circuit may be defective upon manufacturing. The defect may cause the functional unit to appear improper results. Thus, a laser repairing process is required.

However, conventional polarizing films adhered on outer surface of the electronic device have worse transmittance, so the intensity of repairing laser may be reduced Besides, bubbles in the conventional polarizing film may generate while the conventional polarizing film is at high temperature and high humidity. Thus, a new polarizing design is required.

### SUMMARY OF THE DISCLOSURE

According to an embodiment, the present disclosure provides an electronic device including a base substrate and an optical substrate. The optical substrate is disposed opposite to the base substrate and includes an optical region with a plurality of polarizing wires formed therein. A transmittance of the optical region in a wavelength range from 510 nm to 550 nm is ranged from 34% to 57%.

According to another embodiment, the present disclosure provides an electronic device including a base substrate and an optical substrate. The optical substrate is disposed opposite to the base substrate and includes an optical region with a plurality of polarizing wires formed therein. A transmittance of the optical region in a wavelength range from 610 nm to 650 nm is ranged from 37% to 57%.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 schematically illustrates a cross-sectional view of the electronic device according to a first embodiment of the present disclosure.

FIG. 2 schematically illustrates a perspective exploded view of the electronic device according to the first embodiment of the present disclosure.

FIG. 3 schematically illustrates a perspective exploded view of a display device according to a first variant embodiment of the first embodiment of the present disclosure.

FIG. 4 shows a method for measuring the transmittance of the optical region according to the present disclosure.

FIG. 5 schematically illustrates a perspective exploded view of a display device according to a second variant embodiment of the first embodiment of the present disclosure.

FIG. 6 schematically illustrates a cross-sectional view of an optical substrate according to a third variant embodiment of the first embodiment of the present disclosure.

FIG. 7 schematically illustrates a cross-sectional view of a display device according to a second embodiment of the present disclosure.

FIG. 8 schematically illustrates a cross-sectional view of an optical substrate according to a variant embodiment of the second embodiment of the present disclosure.

FIG. 9 schematically illustrates a cross-sectional view of an optical substrate of a display device according to a third embodiment of the present disclosure.

FIG. 10 schematically illustrates a cross-sectional view of an optical substrate of a display device according to a fourth embodiment of the present disclosure.

FIG. 11 schematically illustrates a cross-sectional view of an optical substrate of a display device according to a fifth embodiment of the present disclosure.

### DETAILED DESCRIPTION

The present disclosure may be understood by reference to the following detailed description, taken in conjunction with the drawings as described below. It is noted that, for purposes of illustrative clarity and being easily understood by the readers, various drawings of this disclosure show a portion of the electronic device, and certain elements in various drawings may not be drawn to scale. In addition, the number and dimension of each element shown in drawings are only illustrative and are not intended to limit the scope of the present disclosure.

Certain terms are used throughout the description and following claims to refer to particular elements. As one skilled in the art will understand, electronic equipment manufacturers may refer to an element by different names. This document does not intend to distinguish between elements that differ in name but not function. In the following description and in the claims, the terms “include”, “comprise” and “have” are used in an open-ended fashion, and thus should be interpreted to mean “include, but not limited to . . . ”.

It will be understood that when an element or layer is referred to as being “disposed on” or “connected to” another element or layer, it can be directly on or directly connected to the other element or layer, or intervening elements or layers may be present (indirectly). In contrast, when an element is referred to as being “directly on” or “directly connected to” another element or layer, there are no intervening elements or layers presented.

Although terms such as first, second, third, etc., maybe used to describe diverse constituent elements, such constituent elements are not limited by the terms. The terms are used only to discriminate a constituent element from other constituent elements in the specification. The claims may not use the same terms, but instead may use the terms first, second, third, etc. with respect to the order in which an element is claimed. Accordingly, in the following description, a first constituent element may be a second constituent element in a claim.

It should be noted that the technical features in different embodiments described in the following can be replaced, recombined, or mixed with one another to constitute another embodiment without departing from the spirit of the present disclosure.

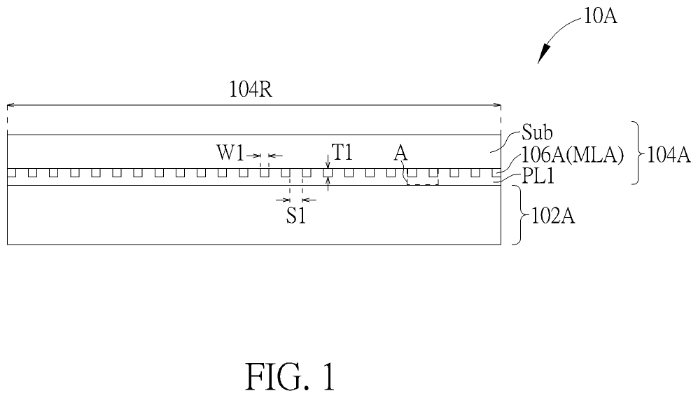

Refer to FIG. 1, which schematically illustrates a cross-sectional view of the electronic device according to a first embodiment of the present disclosure. The electronic device includes abase substrate 102A and an optical substrate 104A disposed opposite to the base substrate 102A. The optical substrate 104A includes an optical region 104R with a plurality of polarizing wires 106A formed therein. The optical region 104R is an effective optical region mapping and corresponding to an active area (including whole functional pixels) of the base substrate 102A. The polarizing wires 106A are overlap the active area of the base substrate 102A. The polarizing wires 106A are formed of opaque conductive, semi-conductive or insulating materials and used for modulating polarizing state of light from the active area of the base substrate 102A while the light penetrating through the polarizing wires 106A. In other words, the polarizing wires 106A serve as a polarizer. According to some embodiments, the electronic device can be for example a display device, such as liquid crystal display device (LCD), organic light-emitting display device (OLED) or inorganic light-emitting display device, a sensing device, a transceiver, or an antenna, such as a liquid crystal antenna. The number of the polarizing wires 106A shown in FIG. 1 is only illustrative and is not limited thereto.

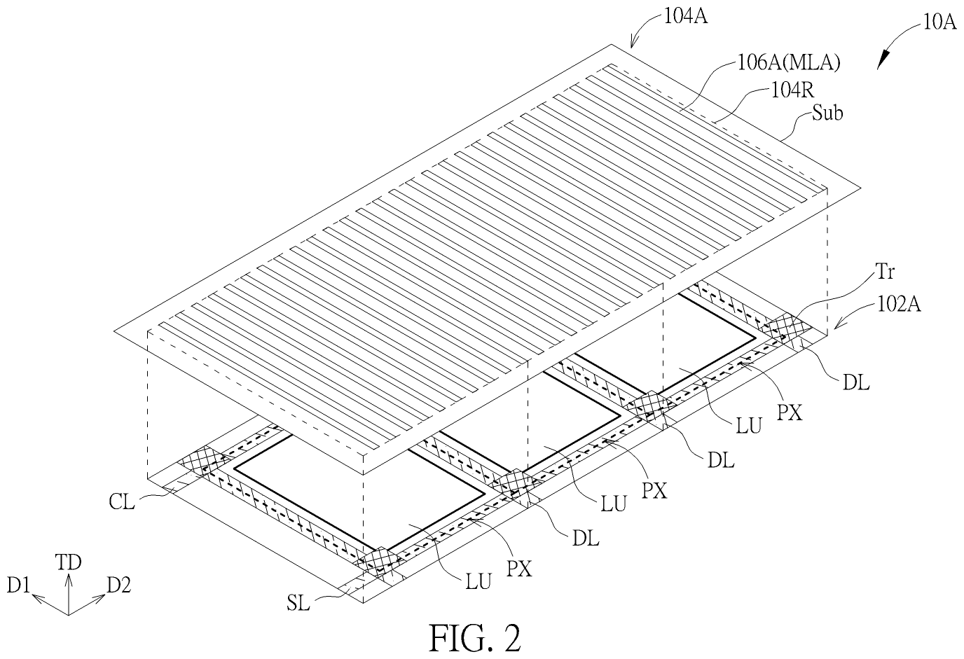

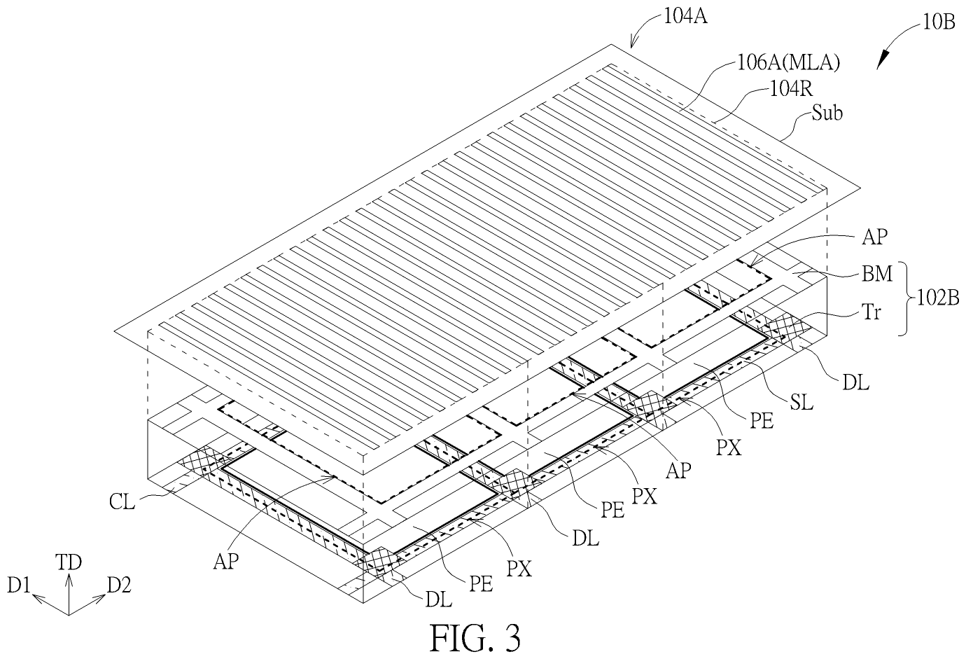

In this embodiment, the electronic device is a display device 10A. In such situation, the base substrate 102 may be a self-luminous display panel, such as an organic light emitting diode (OLED) display panel, a quantum dot light emitting diode (QLED) display panel or a light emitting diode (LED) display panel (a mini LED display panel or a micro LED display panel), or a non-self-luminous display panel, such as a liquid crystal display (LCD) panel. Refer to FIG. 2, which schematically illustrates a perspective exploded view of the electronic device according to the first embodiment of the present disclosure. In this embodiment, the display device 10A is a self-luminous display panel, the base substrate 102 of the display device 10A may comprise a plurality of pixels PX (or a sub-pixel) and a plurality of light emitting units LU, and each of the pixels PX may comprises at least one of the light emitting units LU located therein respectively, but the present disclosure is not limited thereto. Also, the base substrate 102 may include an array circuit for controlling the display of the base substrate 102, in which the array circuit may include scan lines SL, common lines CL, data lines DL and transistors Tr, but the present disclosure is not limited thereto. The base substrate 102 may further comprise a black partition (black mesh partition wall) disposed between adjacent pixels PX and enclosing the light emitting units LU for reducing interference between adjacent ones. Those skilled in the art will understand the array circuit may include other elements, such as storage capacitors, etc., and will not be detailed herein. In a display device 10B of a first variant embodiment shown in FIG. 3, when the display device 10B is a LCD panel, the base substrate 102B of the display device 10B may include an array circuit, a black matrix BM encloses and forms a plurality of apertures AP, and a plurality of pixel electrodes PE (or common electrodes) disposed in the apertures AP respectively and connected to the array circuit respectively. Apertures AP are located within the pixels PX. In such situation, a bottom surface of the base substrate 102B opposite to the optical substrate 104A may further have another polarizing film or other polarizing wires disposed thereon. In addition, the arrangement of the pixels and apertures is not limited to be as the arrangement shown in FIG. 2 and FIG. 3 and may be other arrangement based on the requirements.

In this embodiment, the optical region 104R that has the polarizing wires 106A disposed therein may overlap the pixels PX or apertures AP, so that light from the pixels PX or apertures AP can penetrate through the polarizing wires 106A (white or other gray levels) or be blocked by the polarizing wires 106A (black). In this embodiment, the optical substrate 104A may include a substrate Sub, the polarizing wires 106A disposed on the substrate Sub, and a protection layer PL disposed on the substrate Sub and covering the polarizing wires 106A for preventing oxidation that will degrade the polarization effect of the polarizing wires 106A. Furthermore, the substrate Sub may be may be rigid or flexible.

The laser light used in repairing process maybe in a wavelength range from 510 nm to 550 nm or in a wavelength range from 610 nm to 650 nm; that is the laser light may be green or red. The laser light for repairing in the wavelength range from 510 nm to 550 nm may be for example generated from a neodymium-doped yttrium aluminum garnet (Nd:YAG) laser, a gas laser, such as argon-ion laser, or a semiconductor laser including indium gallium nitride, aluminum(III) oxide(Al₂O₃) or zinc selenide. The laser light for repairing in the wavelength range from 610 nm to 650 nm may be for example generated from a semiconductor laser including aluminum gallium indium phosphide, gallium indium phosphide or gallium arsenide.

In this embodiment, a portion of the optical substrate 104A corresponding to the optical region 104R doesn't include the color conversion layer and other opaque devices except the polarizing wires 106A, i.e. color of light penetrating through the optical region 104R will not be obviously altered. Accordingly, laser lights with different colors may penetrate the optical region 104R, and the transmittance of the optical region 104R in a wavelength range from 510 nm to 650 nm can be ranged from 42% to 57%. Also, the base substrate 102A may optionally include color conversion layers covering the pixels PX or apertures AP, a transmittance of the optical region 104R with green color conversion layer in a wavelength range from 510 nm to 550 nm is ranged from 34% to 57%, or a transmittance of the optical region 104R with red color conversion layer in a wavelength range from 610 nm to 650 nm is ranged from 37% to 57%. In this embodiment, the transmittance of the optical region 104R may be achieved by adjusting a first ratio of a spacing S1 between adjacent two of the polarizing wires 106A to a width W1 of each polarizing wire 106A in the optical region 104R. Specifically, the first ratio is ranged from 0.1 to 4. For example, the spacing S1 maybe ranged from 50 nm to 200 nm, and the width W1 of the polarizing wire 106A may be ranged from 50 nm to 500 nm, thereby improving the performance of laser repairing process.

Although the transmittance of the optical region 104R is increased, the polarization ratio of light is not obviously changed while the light penetrates through the optical region 104R. When the transmittance of the optical region 104R is less than 60%, the polarization ratio of light can still be greater than 95%, which will not affect the performance of the display device 10A. Accordingly, the polarization ratio of the light and the display performance of the display device 10A are not evidently influenced by the increase of the transmittance of the optical region 104R.

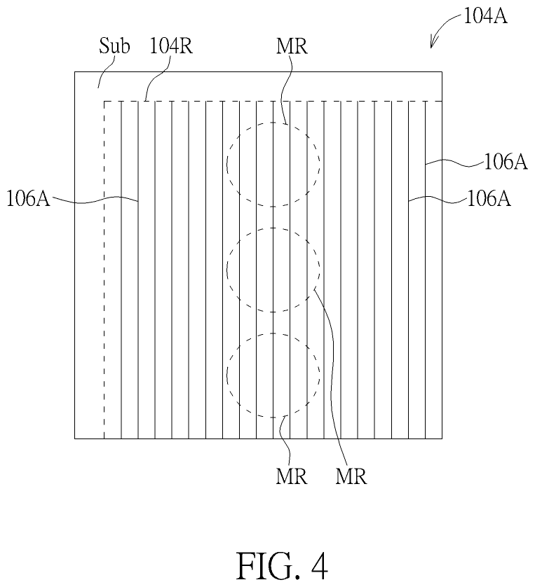

Refer to FIG. 4, which shows a method for measuring the transmittance of the optical region 104R according to the present disclosure. The method for measuring the transmittance of the optical region 104R may include the following steps. First step, light generated from a light source, for example a backlight unit, is provided to penetrate through the optical region 104R of the optical substrate 104A. Second step, a detector measures the intensity of the light at measuring regions MR, and a ratio of the intensity of the light after penetrating through the optical region 104R of the optical substrate 104A to the intensity of the light before penetrating through optical region 104R of the optical substrate 104A can be calculated. The above-mentioned measuring steps may be for example performed at least three times. That is to say, at least three measuring regions MR may be located at a top portion of the optical region 104R, at a middle portion of the optical region 104R and at a bottom portion of the optical region 104R respectively, and the transmittance of the optical region 104R can be obtained by calculating the average of the transmittances. It should be noted that the transmittance of the optical region 104R is measured under condition of the light penetrating through the optical region 104R of the optical substrate 104A instead of penetrating through the whole display device 10A. For example, a cross-sectional size of each measuring regions MR may be ranged from 5 micrometers to 25 centimeters. It is noted that since the protection layer PL is transparent and has transmittance far greater than the polarizing wires 106A, the transmittance of the optical region 104R is mainly dominated by the design of the polarizing wires 106A.

In this embodiment, the transmittance of the optical region 104R may also be achieved by adjusting a second ratio of the width W1 of one of the polarizing wires 106A to a thickness T1 of the polarizing wire 106A in the optical region 104R. Specifically, the second ratio is ranged from 0.06 to 10, so that the transmittance of the optical region 104R in a wavelength range from 510 nm to 650 nm can be ranged from 42% to 57%, a transmittance of the optical region 104R with green color conversion layer is in a wavelength range from 510 nm to 550 nm is ranged from 34% to 57%, or a transmittance of the optical region 104R with red color conversion layer in a wavelength range from 610 nm to 650 nm is ranged from 37% to 57%. For example, the thickness T1 of the polarizing wire 106A is ranged from 50 nm to 800 nm while the width W1 of the polarizing wire 106A is ranged from 50 nm to 500 nm. In another embodiment, the transmittance of the optical region 104R ranged from 42% to 57% may be achieved by complying with either the first ratio or the second ratio.

Additionally, refer to FIG. 1 to FIG. 3 again, in this embodiment, the polarizing wires 106A may be formed of a metal layer MLA, and the metal layer MLA may include molybdenum, aluminum, gold, silver, copper or titanium, in which since an extinction coefficient of aluminum is the best of the above-mentioned materials. The polarizing wires 106A may be single layered or multi layered. Since the polarizing wires 106A are formed of metal, no bubbles will be generated at high temperature and high humidity. Also, the extending direction of each polarizing wire 106A in the optical region 104R may be substantially parallel to an extending direction (that is the first direction D1) of data lines DL, but the present disclosure is not limited thereto. In some embodiment, the extending direction of polarizing wires 106A may be substantially parallel to an extending direction (that is the second direction D2) of scans lines SL or common lines CL. In some embodiment, the extending direction of polarizing wires 106A may be inclined to the first direction D1 or the second direction D2. Furthermore, in this embodiment, a profile of one of the polarizing wires 106A may be for example rectangular, but the present disclosure is not limited thereto. The polarizing wires 16D may be electrically connected or electrically isolated.

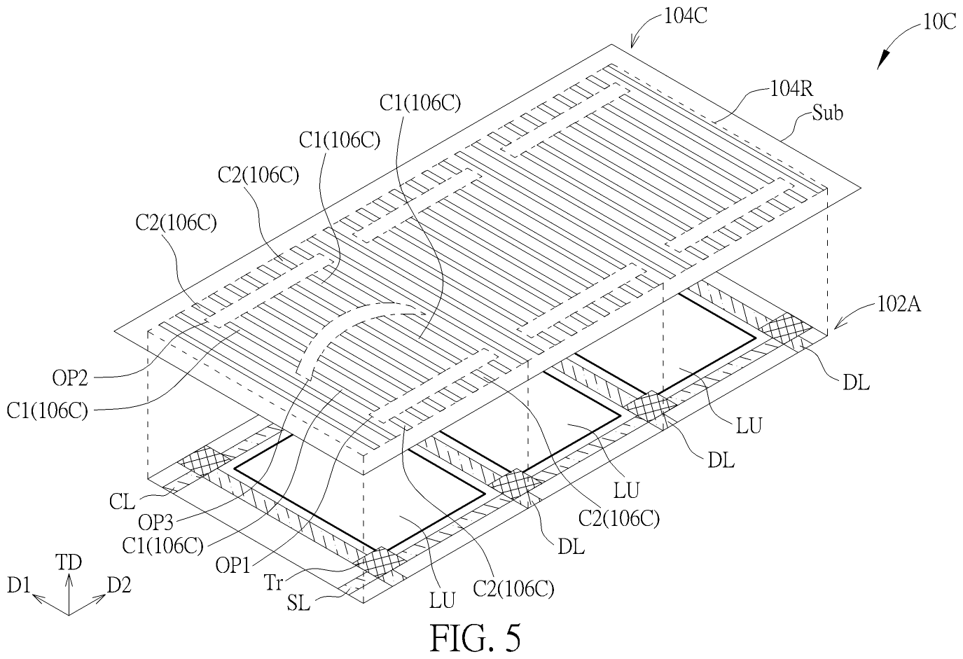

The transmittance of the optical region 104R may be achieved by other method. Refer to FIG. 5, which schematically illustrates a perspective exploded view of a display device according to a second variant embodiment of the first embodiment of the present disclosure. In the display device 10C of this variant embodiment, the polarizing wires 106C of the optical substrate 104C may have at least one opening corresponding to at least one of the opaque devices on the base substrate 102A. In this embodiment, a first opening OP1 and a second opening OP2 disposed between the polarizing wires 106C, in which the first opening OP1 overlaps one of the scan lines SL, and the second opening OP2 overlaps one of the common lines CL. In this embodiment, one end of each first polarizing wire C1 is spaced apart from the corresponding scan line SL in the top view, and the other end of each first polarizing wire C1 is spaced apart from the corresponding common line CL in the top view. In another embodiment, the end of each first polarizing wire C1 may be aligned with a side of the corresponding scan line SL in the top view. The other end of each first polarizing wire C1 may be optionally aligned with a side of the corresponding common line CL in the top view. In this variant embodiment, the polarizing wires 106C may optionally include a third opening OP3 overlapping one of the light emitting units LU or the apertures AP in the top view.

The profile of the polarizing wire is not limited to be the above-mentioned rectangular. The profile of the polarizing wire may be direct-trapezoid-shaped, inverted-trapezoid shape, or combine with a dome-shaped portion. Since the direct-trapezoid-shaped surface, the inverted-trapezoid shape surface, or the dome-shaped top surface will cause the light to be diverged when the light penetrates through the gap between two of the polarizing wires, through the design of this embodiment, a diverged angle between the propagation direction of the light and a propagation direction of diverged light can be less than or equal to 0.5 degree, thereby providing a collimator light and enhancing the polarization ratio.

In this embodiment, the protection layer PL1 may include a silicon nitride layer 116 and a silicon oxide layer 118. The thickness of the polarizing wire 106A is greater than a thickness of the silicon nitride layer 116, so that the effect of the silicon nitride layer 116 and the silicon oxide layer 118 on the polarization can be mitigated.

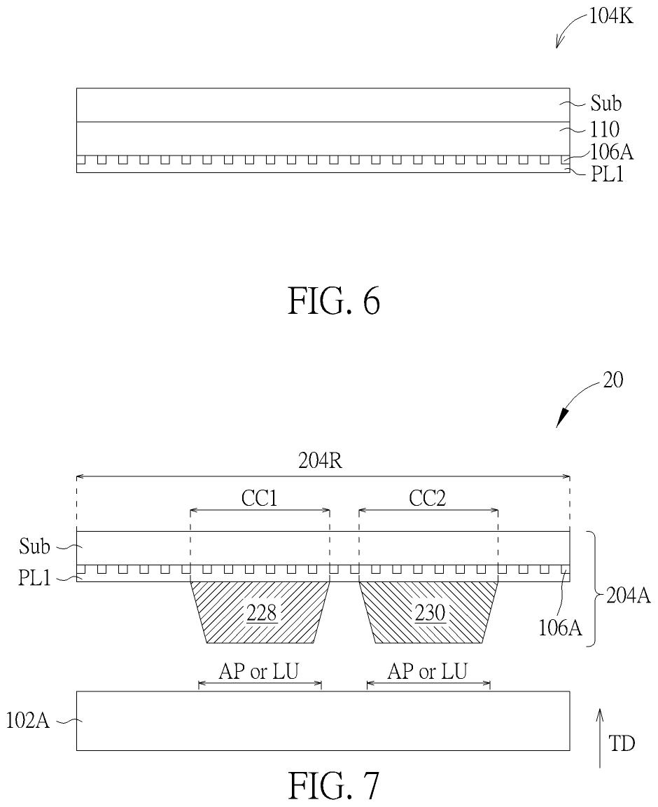

Refer to FIG. 6, which schematically illustrates a cross-sectional view of an optical substrate according to a third variant embodiment of the first embodiment of the present disclosure. In this variant embodiment, the optical substrate 104K may further include a planarization layer 110 disposed between the polarizing wires 106A and the substrate Sub. In another embodiment, the optical substrate may not have the protection layer while having the planarization layer.

The display device of the present disclosure is not limited to the above embodiment. Further embodiments of the present disclosure are described below. To compare the embodiments conveniently and simplify the description, the same component would be labeled with the same symbol in the following. The following description will detail the dissimilarities among different embodiments and the identical features will not be redundantly described.

Refer to FIG. 7, which schematically illustrates a cross-sectional view of a display device according to a second embodiment of the present disclosure. As compared with the first embodiment shown in FIG. 1 and FIG. 2, the optical region 204R of this embodiment includes a first color conversion region CC1 for allowing the light with the wavelength range from 510 nm to 550 nm penetrating through. The first color conversion region CC1 may correspond to and cover one of the aperture AP or light emitting unit LU in the top view (in the thickness direction TD). Specifically, the optical substrate 204A of the display device 20 further includes a first color conversion layer 228 covering the first color conversion region CC1, and the first color conversion layer 228 is for example a green color filter layer, a green phosphor layer or a quantum dot layer for generating green light. In this embodiment, since the first color conversion layer 228 allows the light with the wavelength range from 510 nm to 550 nm penetrating through, the transmittance of the first color conversion region CC1 in a wavelength range from 510 nm to 550 nm is ranged from 34% to 52%. Thus, the display device 20 is adapted to the laser repairing using the laser light with the wavelength range from 510 m to 550 nm. In this embodiment, the base substrate 102A is disposed under the optical substrate 204A. In some embodiments, the optical substrate may be disposed upside down, so a surface of the substrate without forming the polarizing wires may face the base substrate. In a variant embodiment, a planarization layer could be disposed between the substrate Sub and the polarizing wires 106A. In a variant embodiment, a filing layer could replace protection layer and planarization layer, the filing layer covering a port of the substrate Sub, the polarizing wires 106A, the first color conversion layer 328, or the second color conversion layer 330.

In this embodiment, the optical region 204R may further include a second color conversion region CC2 for allowing the light with the wavelength range from 610 nm to 650 nm penetrating through. The second color conversion region CC2 may correspond to and cover another one of the aperture AP or light emitting unit LU in the top view (in the thickness direction TD). Specifically, the optical substrate 204A of the display device 20 further includes a second color conversion layer 230 covering the second color conversion region CC2, and the second color conversion layer 230 is for example a red color filter layer, a red phosphor layer or a quantum dot layer for generating red light. In this embodiment, since the second color conversion layer 230 allows the light with the wavelength range from 610 nm to 650 nm penetrating through, the transmittance of the second color conversion region CC2 of this embodiment in a wavelength range from 610 nm to 650 nm is ranged from 37% to 52%. Thus, the display device 20 is adapted to the laser repairing using the laser light with the wavelength range from 610 m to 650 nm. The transmittance of the first color conversion region CC1 ranged from 34% to 52% and the transmittance of the second color conversion region CC2 ranged from 37% to 52% may be achieved by at least one of the methods of the above-mentioned embodiments, for example by adjusting a first ratio of the spacing S1 between adjacent two of the polarizing wires 106A to the width W1 of each polarizing wire 106A to be ranged from 0.1 to 4, adjusting a second ratio of the width W1 of each polarizing wire 106A to the thickness T1 of each polarizing wire 106A to be ranged from 0.06 to 10, or disposing the first opening OP1 or the second opening OP2 in the polarizing wires 106C or disposing the third opening OP3 in the polarizing wires 106C. In this embodiment, the base substrate of the display device 20 may not have the first color conversion layer or the second color conversion layer.

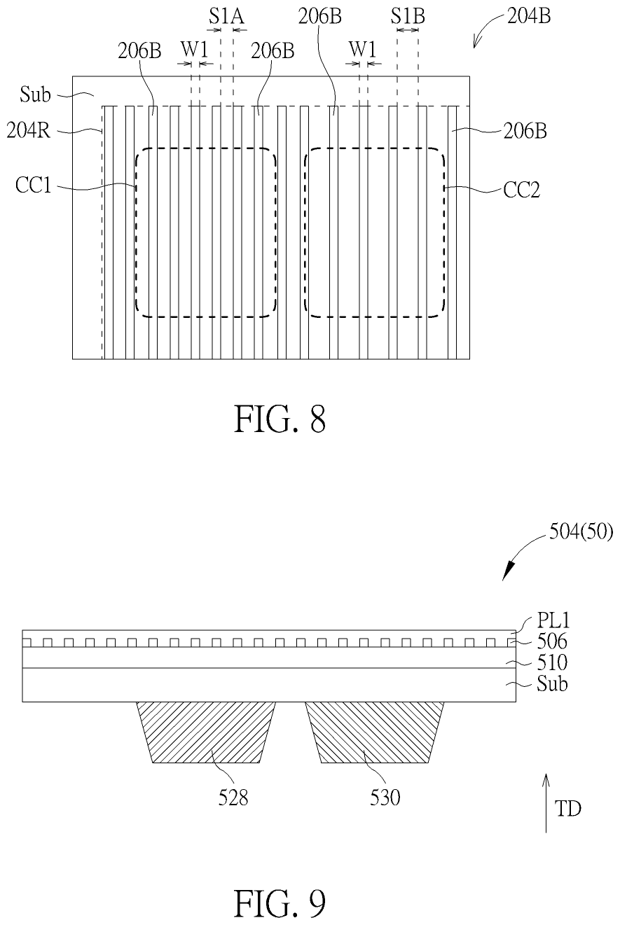

Refer to FIG. 8, which schematically illustrates a cross-sectional view of an optical substrate according to a variant embodiment of the second embodiment of the present disclosure. As compared with the second embodiment shown in FIG. 7, in the optical substrate 204B of this embodiment, a spacing S1A between adjacent two of the polarizing wires 206B in the first color conversion region CC1 may be less than the spacing S1B between adjacent two of the polarizing wires 206B in the second color conversion region CC2 while the width W1 of each polarizing wire 206B in the first color conversion region CC1 is the same as the width W1 of each polarizing wire 206B in the second color conversion region CC2.

Refer to FIG. 9, which schematically illustrates a cross-sectional view of an optical substrate of a display device according to a third embodiment of the present disclosure. As compared with the previous embodiments, the substrate Sub is disposed between the polarizing wires 506 and the first color conversion layer 528 and between polarizing wires 506 and the second color conversion layer 530. Furthermore, the planarization layer 510 disposed between the polarizing wires 406 and the substrate Sub, and the polarizing wires 506 are disposed between the protection layer PL1 and the planarization layer 510. In another embodiment, the optical substrate may not include the planarization layer when the substrate is disposed between polarizing wires and the first color conversion layer and between the polarizing wires and the second color conversion layer. Alternatively, in another embodiment, the optical substrate may not include the protection layer when the substrate is disposed between polarizing wires and the first color conversion layer and between the polarizing wires and the second color conversion layer.

Refer to FIG. 10, which schematically illustrates a cross-sectional view of an optical substrate of a display device according to a fourth embodiment of the present disclosure. As compared with the previous embodiments, the first color conversion layer 628 and the second color conversion layer 630 of this embodiment may be disposed between the polarizing wires 606 and the substrate Sub. In this embodiment, the optical substrate 604 of the display device 60 may optionally further include a first transflective layer 634 and a second transflective layer 636, in which the first transflective layer 634 is disposed between the first color conversion layer 628 and the substrate Sub and between the second color conversion layer 630 and the substrate Sub, and the second transflective layer 636 is disposed between the first color conversion layer 628 and the polarizing wires 606 and between the second color conversion layer 630 and the polarizing wires 606. The first transflective layer 634 maybe a reflector for reflecting light with wavelength in a specific wavelength range, such as blue light wavelength range, and allowing light with wavelength outside the first specific wavelength range to penetrate through, for example the first transflective layer 634 maybe a distributed Bragg reflector (DBR). The second transflective layer 636 may be a reflector for allowing light with wavelength in a specific wavelength range (for example the same as the specific wavelength range of the first transflective layer) to penetrate through and reflecting light with wavelength outside the specific wavelength range, for example the second transflective layer 636 may also be a DBR. Since the second transflective layer 636 is uniformly and directly formed on the first transflective layer 634, the first color conversion layer 628 and the second color conversion layer 630, the second transflective layer 636 and the polarizing wires 606 and the protection layer PL1 formed thereon are uneven. In another embodiment, the optical substrate may not include the first transflective layer and the second transflective layer. In another embodiment, the optical substrate may include one of the first transflective layer and the second transflective layer but not include the other one of the first transflective layer and the second transflective layer.

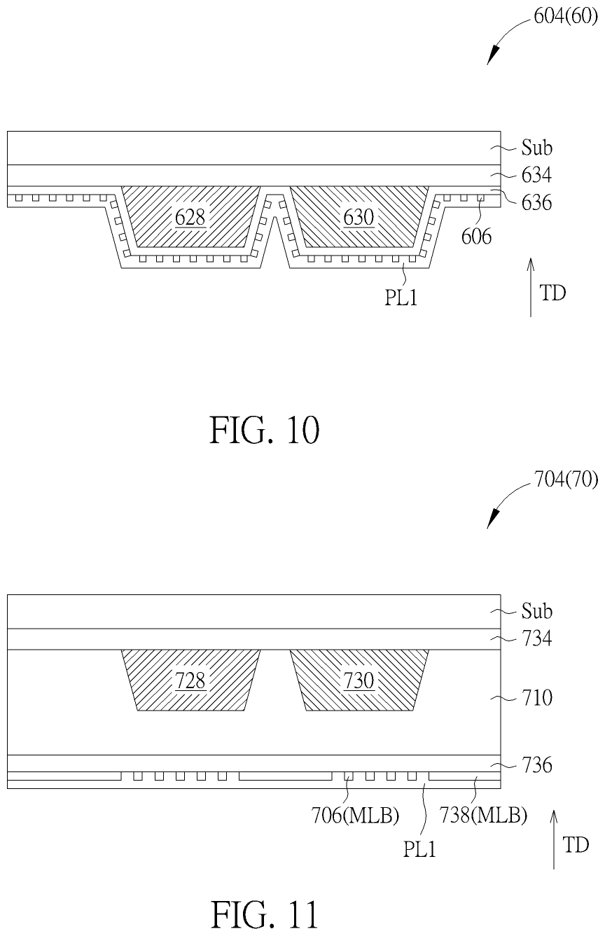

Refer to FIG. 11, which schematically illustrates a cross-sectional view of an optical substrate of a display device according to a fifth embodiment of the present disclosure. As compared with the previous embodiments, the optical substrate 704 of the display device 70 provided in this embodiment may further include a planarization layer 710 disposed between the polarizing wires 706 and the first color conversion layer 728 and between the polarizing wires 706 and the second color conversion layer 730, so as to provide a flat surface to the polarizing wires 706 and the protection layer PL1 disposed thereon. In this embodiment, the second transflective layer 736 is disposed between the planarization layer 710 and the polarizing wires 706, so the second transflective layer 736 may also be planar. In addition, the metal layer MLB for forming the polarizing wires 706 may further include at least one light shielding block 738, in which the light shielding block 738 covers a gap between the first color conversion layer 728 and the second color conversion layer 730 in the top view (in the thickness direction TD).

According to the present disclosure, the transmittance of the optical region in a wavelength range from 510 nm to 550 nm is increased to be ranged from 34% to 57%, or the transmittance of the optical region in a wavelength range from 610 nm to 650 nm is increased to be ranged from 37% to 57%, so more laser light with a wavelength ranged from 510 nm to 550 nm or more laser light with a wavelength ranged from 610 nm to 650 nm can penetrate through the optical region, thereby improving the effect of the laser repairing process under the condition without obviously changing the polarization ratio of light. According some embodiments, the transmittance of the optical region may be achieved by adjusting a first ratio of the spacing between adjacent two of the polarizing wires to the width of each polarizing wire in the optical region to be ranged from 0.1 to 4, by adjusting a second ratio of the width of each polarizing wire to the thickness of each polarizing wire in the optical region to be ranged from 0.06 to 10, or by disposing the first opening or the second opening in the polarizing wires or disposing the third opening in the polarizing wires.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. An electronic device, comprising:
a base substrate; and
an optical substrate disposed opposite to the base substrate and comprising an optical region with a plurality of polarizing wires formed therein;
wherein a transmittance of the optical region in a wavelength range from 510 nm to 550 nm is ranged from 34% to 57%.

2. The electronic device of claim 1, wherein the optical region further comprising a first color conversion region, wherein a transmittance of the first color conversion region in the wavelength range from 510 nm to 550 nm is ranged from 34% to 52%.

3. The electronic device of claim 2, wherein the optical substrate further comprises a first color conversion layer in the first color conversion region.

4. The electronic device of claim 1, wherein the optical region further comprising a first spacing located between adjacent two of the plurality of polarizing wires and a second spacing located between another adjacent two of the plurality of polarizing wires, and the first spacing is different from the second spacing.

5. The electronic device of claim 4, wherein the optical region further comprising a first color conversion region and a second color conversion region, wherein a transmittance of the first color conversion region in the wavelength range from 510 nm to 550 nm is ranged from 34% to 52%, and a transmittance of the second color conversion region in a wavelength range from 610 nm to 650 nm is ranged from 37% to 52%.

6. The electronic device of claim 5, wherein the optical substrate further comprises a second color conversion layer in the second color conversion region.

7. The electronic device of claim 5, wherein the first spacing corresponds to the first color conversion region, and the second spacing corresponds to the second color conversion region.

8. The electronic device of claim 7, wherein the first spacing is less than the second spacing.

9. The electronic device of claim 1, wherein a first ratio of a spacing between adjacent two of the plurality of polarizing wires to a width of one of the plurality of polarizing wires is ranged from 0.1 to 4.

10. The electronic device of claim 1, wherein a second ratio of a width of one of the plurality of polarizing wires to a thickness of the one of the plurality of polarizing wires is ranged from 0.06 to 10.

11. The electronic device of claim 1, wherein the base substrate further comprises a plurality of light emitting units, and the plurality of polarizing wires overlap the plurality of light emitting units.

12. The electronic device of claim 1, wherein the base substrate further comprises a black matrix enclosing a plurality of apertures, and the plurality of polarizing wires overlap the plurality of apertures.

13. An electronic device, comprising:
a base substrate; and
an optical substrate disposed opposite to the base substrate and comprising an optical region with a plurality of polarizing wires formed therein;
wherein a transmittance of the optical region in a wavelength range from 610 nm to 650 nm is ranged from 37% to 57%.

14. The electronic device of claim 13, wherein the optical region further comprising a second color conversion region, wherein a transmittance of the second color conversion region in the wavelength range from 610 nm to 650 nm is ranged from 37% to 52%.

15. The electronic device of claim 14, wherein the optical substrate further comprises a second color conversion layer in the second color conversion region.

16. The electronic device of claim 13, wherein a first ratio of a spacing between adjacent two of the plurality of polarizing wires to a width of one of the plurality of polarizing wires is ranged from 0.1 to 4.

17. The electronic device of claim 13, wherein a second ratio of a width of one of the plurality of polarizing wires to a thickness of the one of the plurality of polarizing wires is ranged from 0.06 to 10.

18. The electronic device of claim 13, wherein the base substrate further comprises a plurality of light emitting units, and the plurality of polarizing wires overlap the plurality of light emitting units.

19. The electronic device of claim 13, wherein the base substrate further comprises a black matrix enclosing a plurality of apertures, and the plurality of polarizing wires overlap the plurality of apertures.
